(19) United States
(12) Patent Application Publication
(10) Pub. No.: US 2003/0213344 A1
(43) Pub. Date: Nov. 20, 2003

(54) Saw chain

(75) Inventor: Bernd Andress, Erdmannhausen (DE)

Correspondence Address: ROBERT W. BECKER & ASSOCIATES, Suite B, 707 Highway 66 East, Tijeras, NM, 87059, US

(73) Assignee: Andreas Stihl AG & Co. KG, Waiblingen (DE)

(21) Appl. No.: 10/439,082

(22) Filed: May 15, 2003

(30) Foreign Application Priority Data
May 17, 2002 (DE) 102 21 944.3

(51) Int. Cl. B21K 5/12; B26D 1/46; B21K 11/00; B27B 33/02; B27B 33/14; B26D 1/00; B26D 3/00; B27B 13/02; B23D 57/00

(52) U.S. Cl. 83/13; 83/831; 76/82; 83/835

(57) ABSTRACT

A saw chain for a power chain saw is provided and is formed of centrally disposed drive links and laterally disposed connecting links. The links have a flat main body which has two rivet openings through which, transverse to the longitudinal direction of the chain, rivet pins extend for a pivotable connection of the links. Some of the connecting links are embodied as cutter links, which have a cutting tooth formed on the main body, whereby at least one depth limiter is disposed in a manner so as to lead each cutting tooth. At least one part of the depth limiter is fixed in position on a chain link that is disposed on the inner side of the cutter link, and that edge of the cutting tooth that is disposed toward the front in a direction of travel extends parallel to that edge of the leading depth limiter that is disposed toward the rear in a direction of travel.

### BACKGROUND OF THE INVENTION

The present invention relates to a saw chain for a power chain saw, as well as to a method of re-sharpening or re-grinding a saw chain.

U.S. Pat. No. 6,102,632 discloses a cutter link for a saw chain of a power chain saw, and has a depth limiter that leads a cutting tooth. The depth limiter has a support stay that is formed on the base body of the cutter link, and also has a top portion that is bent out of the plane of the base body. Such depth limiters are re-ground from the top.

During operation, the depth limiter is subjected to high stresses, so that it must be appropriately strong. It is possible to re-grind the depth limiter only to the point where a minimum thickness still remains. This limits the service life of the saw chain.

It is therefore an object of the present invention to provide a saw chain of the aforementioned general type that has a long service life, and also to provide a method for re-grinding a saw chain.

### BRIEF DESCRIPTION OF THE DRAWINGS

These and other objects and advantages of the present invention will appear more clearly from the following specification in conjunction with the accompanying schematic drawings, in which:

FIG. 1 is a side view of a power chain saw;

FIGS. 2 & 3 show perspective views of a portion of a saw chain;

FIG. 4 is a side view of the saw chain portion of FIGS. 2 and 3;

FIG. 5 is a plan view of the saw chain of FIG. 4;

FIG. 6 is a perspective view of a cutter link;

FIGS. 7-9 are side views of the cutter link of FIG. 6;

FIG. 10 is a plan view of the cutter link of FIG. 6;

FIG. 11 is a perspective view of a connecting link;

FIGS. 12 & 14 are side views of the connecting link of FIG. 11;

FIG. 15 is a plan view of the connecting link of FIG. 11;

FIGS. 16 & 17 are perspective views of a portion of a saw chain;

FIG. 18 is a side view of the saw chain portion of FIGS. 16 and 17;

FIG. 19 is a plan view of the saw chain portion of FIG. 18;

FIGS. 20 & 21 are perspective views of a portion of a saw chain;

FIG. 22 is a side view of the saw chain portion of FIGS. 20 and 21;

FIG. 23 is a plan view of the saw chain portion of FIG. 22;

FIGS. 24 & 25 are perspective views of a portion of a saw chain;

FIG. 26 is a side view of the saw chain portion of FIGS. 24 and 25;

FIG. 27 is a plan view of the saw chain portion of FIG. 26;

FIG. 28 is a perspective view of a drive link;

FIGS. 29 & 30 are side views of the drive link of FIG. 28;

FIG. 31 is a plan view of the drive link of FIG. 28;

FIG. 32 is a perspective view of a drive link;

FIGS. 33 & 34 are side views of the drive link of FIG. 32; and

FIG. 35 is a plan view of the drive link of FIG. 32

### SUMMARY OF THE INVENTION

The saw chain of the present invention comprises centrally disposed drive links and laterally disposed connecting links, wherein the drive links and connecting links respectively have a flat main body that has two rivet opening through which, transverse to a longitudinal direction of the chain, rivet pins extend for a pivotable connection of the links, wherein the connecting links have an outer side disposed on one longitudinal side of the chain, and an inner side disposed on an opposite side of the chain, wherein some of the connecting links are embodied as cutter links, which have a cutting tooth formed on the main body, wherein at least one depth limiter is provided that is disposed in a manner so as to lead the cutting tooth in the direction of travel of the chain, wherein the depth limiter has at least one part that is fixed in position on one of the drive links and connecting links that is disposed on the inner side of the cutter link, and wherein an edge of the cutting tooth that is disposed toward the front as viewed in the direction of travel of the chain extends parallel to an edge of the leading depth limiter that is disposed toward the rear as viewed in the direction of travel of the chain.

The inventive method of sharpening or grinding a saw chain for a power chain saw that is formed of drive links and connecting links, wherein some of the connecting links are embodied as cutter links that have a cutting tooth, and wherein a depth limiter is provided for each cutting tooth and leads the same, includes the step of grinding an edge of the depth limiter that is disposed toward the rear as viewed in the direction of travel of the chain, wherein the grinding is effected parallel to an edge of the cutting tooth that is disposed toward the front as viewed in the direction of travel of the chain.

The parallel orientation of that edge of the cutting tooth that is disposed toward the front in the direction of travel, and of that edge of the leading depth limiter that is disposed toward the rear in the direction of travel, makes it possible to re-grind the depth limiter at that edge that faces the cutting tooth. Thus, the regrinding only slightly adversely affects the strength of the depth limiter. The connection of the depth limiter on the wide side, i.e. on a chain link that is disposed on the inner side of the cutter link, ensures that during the regrinding, the depth limiter is not excessively weakened in the region of its connection to the saw chain. A depth limiter that is embodied in this manner leads to a long service life of the saw chain. The depth limiter can be easily re-ground with a grinding disk for the tooth sharpening with standard settings. Furthermore, there is a low sensitivity to tolerances during the re-grinding of the depth limiter, and thus a precise, uniform spacing between the depth limiter and the cutting tooth. Due to the uniform spacing or gap between the depth limiter and the top cutter of the cutting tooth, improved cutting properties result and vibrations are reduced. By disposing at least one portion of the depth limiter on a different chain link than the cutter link, it is possible to form the depth limiter from a different material, or in a different material composition or a different heat-treatment condition. The depth limiter can thus advantageously be formed from a tougher material than is the cutter tooth.

The portion of the depth limiter that is fixed in position on the inner side of the cutter link advantageously has a side part and a top part that is angled-off relative to the side part; the top part at least partially spans the saw chain. In the region of the main body, the length of the side part expediently corresponds at least to the length of the top part on that side that faces the side part. The cross-sectional area via which the forces are introduced from the depth limiter into the saw chain is consequently relatively large, which results in a great stability of the depth limiter. During the re-sharpening or re-grinding of the depth limiter, the side part is thus at most slightly reground, and only in conformity to the top part of the depth limiter. In conformity with the cutter tooth, the thickness of the top part can be reduced in the direction of the free end.

It is provided that the cutter tooth be inclined relative to the plane of the main body on that longitudinal side of the chain on which the pertaining cutter link is disposed by an angle that opens in the direction of travel, and that the upper, outer edge of the leading depth limiter be inclined relative to the plane of the main body on this longitudinal side of the chain by an angle that opens counter to the direction of travel, whereby the ratio of the angle of inclination of the cutter tooth to the plane of the main body, to the angle of inclination of the cutter tooth to the longitudinal direction of the chain in the plane of the main body, corresponds approximately to the ratio of the angle of inclination of the depth limiter to the plane of the main body, to the angle of inclination of the depth limiter to the longitudinal direction of the chain in the plane of the main body. During the re-grinding of the depth limiter, that side of the depth limiter that faces the cutter tooth is shortened due to the inclination of that side of the depth limiter that extends in the longitudinal direction of the chain. A corresponding situation exists for that side of the cutter tooth that faces the depth limiter. Due to the approximately corresponding angular relationships, the sides of the depth limiter and of the cutter tooth are, however, shortened to the same extent. In particular, the depth limiter is spaced relative to the following cutter tooth on that longitudinal side of the chain on which the cutter tooth is disposed, and in a direction perpendicular to the longitudinal direction of the chain. At corresponding angles on the depth limiter and on the cutter link, this spacing remains constant during the regrinding or re-sharpening of the saw chain. As a consequence of the free end of the depth limiter on the cutter tooth side, the shape of the depth limiter can to a large extent be adapted to requirements in an unlimited manner.

In the region of its free end, the depth limiter is advantageously supported relative to the saw chain. Operating forces that occur can thus be easily introduced into the saw chain. By supporting the top portion on both sides, a high stability of the depth limiter is achieved. The depth limiter in particular has an approximately U-shaped configuration, which leads to an increased stability. In addition, this results in a good guiding and support function of the depth limiter.

The depth limiter is advantageously formed of at least two parts. This ensures a good ease of manufacture. In particular, one part of the depth limiter adjoins the main body of the connecting link in a planar manner. The planar portion is expediently disposed on the longitudinal chain side of the cutter link in a manner so as to lead the cutter link.

In particular, one part of the depth limiter is monolithically formed with a cutter link on one longitudinal side of the chain, and one part of the depth limiter is monolithically formed, on the other longitudinal side of the chain, with a connecting link that is disposed opposite to the cutter link. However, it can also be expedient for one part of the depth limiter to be disposed, on the one longitudinal side of the cutter link, on a connecting link that leads the cutter link, and for one part to be disposed on an oppositely disposed connecting link of the other longitudinal side of the chain. It can be advantageous for one part of a depth limiter to be monolithically formed with a drive link. It can also be expedient for the depth limiter, not only on that longitudinal side of the chain on which the pertaining cutter link is disposed, but also on the oppositely disposed longitudinal side of the chain relative to the longitudinal direction of the chain, to be inclined by an angle that opens counter to the direction of travel. This provides an improved, low-vibration, guidance in the cutting groove.

For the inventive method for the sharpening or grinding of a saw chain for a power chain saw, it is provided that the depth limiter be ground, on that edge that is disposed toward the rear in the direction of travel, parallel to that edge of the cutter tooth that is disposed toward the front in the direction of travel. The depth limiter and the cutter tooth can thus be ground with a grinding disk, the side surfaces of which extend parallel to the edges that are to be ground. In particular, on both longitudinal sides of the chain, relative to the longitudinal direction of the chain, the depth limiter is inclined by an angle that opens counter to the direction of travel. For the inventive method, it is then provided that during the grinding both sides are shortened in such a way that the distance of the depth limiter from the cutter tooth, perpendicular to the longitudinal direction of the chain, be constant on both longitudinal sides of the chain.

Further specific features of the present invention will be described in detail subsequently.

### DESCRIPTION OF PREFERRED EMBODIMENTS

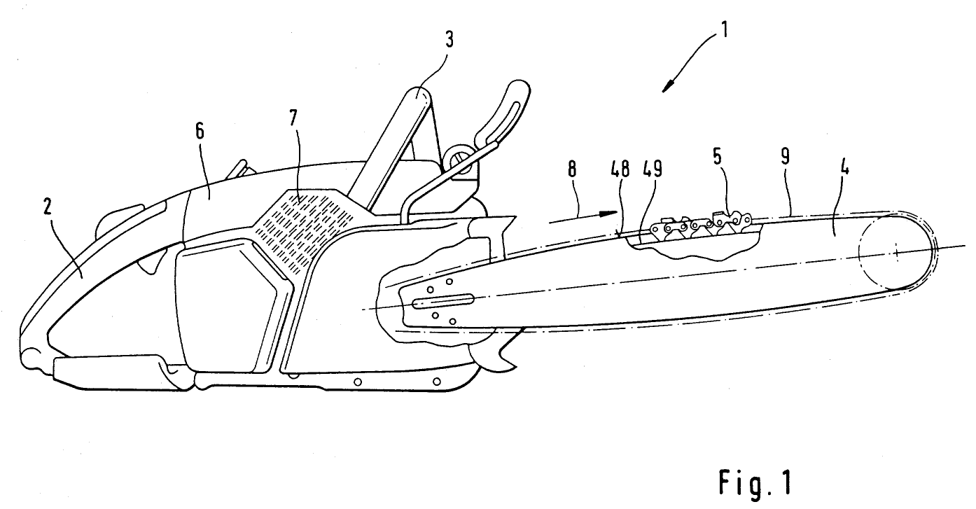

Referring now to the drawings in detail, the power chain saw 1 schematically illustrated in FIG. 1 has a housing 6 and an internal combustion engine 7 that is disposed therein. The engine 7 serves for driving a saw chain 5 that is guided in a guide bar 4. In this connection, the saw chain 5 is moved in a direction of travel 8 parallel to the longitudinal direction 9 of the chain. For the operation of the power chain saw 1, disposed on the housing 6 are a grip 2 and a tubular handle 3 that extends over the housing 6.

An enlarged, perspective view of a portion of the saw chain 5 is illustrated in FIGS. 2 and 3. The saw chain 5 is composed of outer connecting links 12 and inwardly disposed drive links 11. The chain links are hingedly or pivotably connected via rivet pins 10 that extend transverse to the longitudinal direction 9 of the chain. In this connection, the rivet pins extend through the rivet openings 23, 24, whereby each connecting link 12 and each drive link 11 has a front rivet opening 23 in the region of a front main body portion 28, and a rear rivet opening 24 in the region of rear main body portion 29. The rear rivet opening 24 is illustrated, for example, in FIG. 11 for a connecting link.

Each connecting link 12 comprises a main body 14 which, relative to the direction of travel 8, has a front support surface 25 and a rear support surface 26. The front support surface 25 extends approximately below the front rivet opening 23, and the rear support surface 26 extends approximately below the rear rivet opening 24. The support surfaces 25, 26 rest upon the guideway 48, which is illustrated in FIG. 1 and is formed to the right and to the left of a guide groove 49 in the outer periphery of the guide bar 4. The drive links 11, which are guided in the guide groove 49 in the guide bar 4, are provided with a lubrication groove 27. The connecting links 12 are partially embodied as cutter links 13. Formed on a cutter link 13 is a cutting tooth 15. Leading the cutting tooth 15 there is formed on the saw chain 5 a depth limiter 18. The depth limiter 18 illustrated in FIG. 3 has an approximately U-shaped configuration and forms with the saw chain 5 a closed structure. In this connection, the closed structure, in a cross-section perpendicular to the longitudinal direction 9 of the chain, is formed by the depth limiter 18, the two outwardly disposed connecting links 12 and a drive link 11.

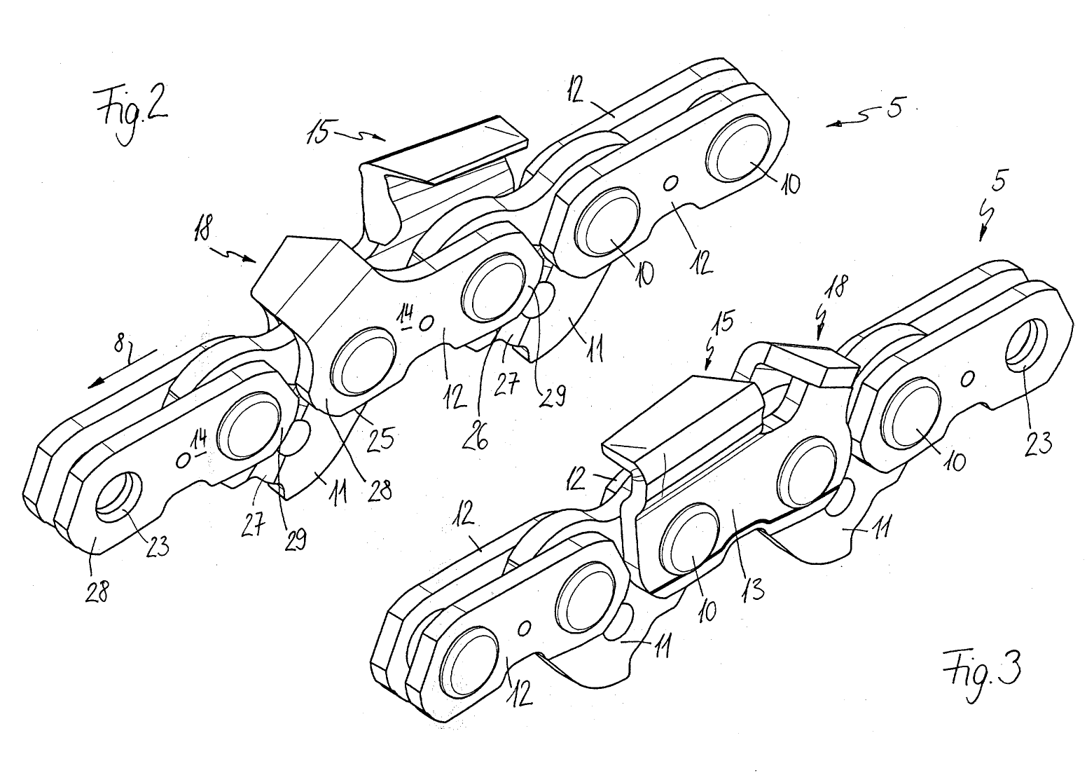

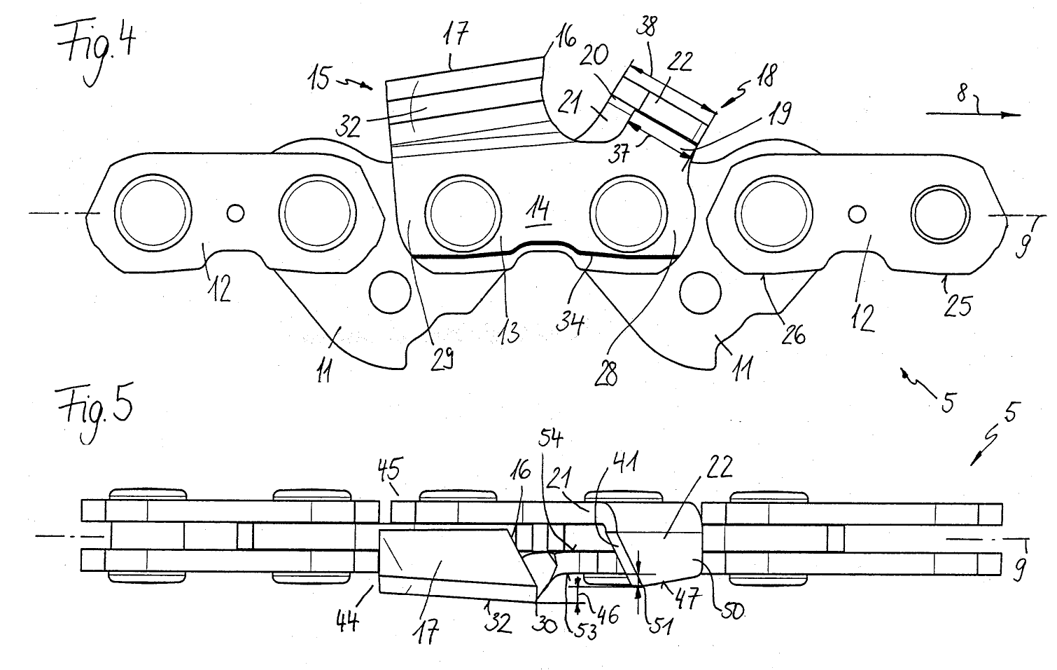

As illustrated in the side view of FIG. 4, and in the plan view of FIG. 5, the cutting tooth 15 is formed of an element 32, which is formed on the main body 14, and a tooth top 17, which extends approximately perpendicular to the element 32. Formed on the tooth top 17, on that edge that is disposed toward the front in the direction of travel 8, is the top cutter 16, and formed on the element 32 is the side cutter 30, which adjoins the top cutter 16. Leading the cutting tooth 15 is the depth limiter 18, which is formed of a planar portion 19, which is formed on the cutter link 13, and an angled-off portion 20, which is disposed on the connecting link 12. The angled-off portion 20 is formed of a side part 21, which extends parallel to the main body 14, and a top part 22, which extends approximately at right angles to the side part 21. The cutter link 13 has an outer side 53, which is disposed on the longitudinal side 44 of the chain and faces away from the saw chain 5, and an oppositely disposed inner side 54. The connecting link 12, on which is formed the angled-off portion 20 of the depth limiter 18, is disposed on the inner side 54 of the cutter link 13. The top part 22 of the angled-off portion 20, in the region of its free end 50, is disposed on the planar portion 19 and is thereby supported relative to the saw chain 5. The support of the free end 50 relative to the saw chain 5 leads to a greater stability of the depth limiter 18, and represents a specific inventive concept.

The edge 41 of the top part 22, which edge is disposed counter to the direction of travel, extends parallel to the top cutter 16 of the cutting tooth 15. That side 47 of the top part 22 that faces away from the side part 21 is spaced from the side cutter 30 by a distance 46. In this connection, the side 47 forms the upper, outer edge of the depth limiter 18. Due to the inclination of the edge 41 relative to the longitudinal direction 9 of the chain, the length 37 of the planar portion 19, as measured parallel to the top part 22, is less than the length 38 of the top part 22 as measured in the plane of the side part 21. The length of the top part 22 parallel to the longitudinal direction 9 of the chain, in the region of the free end 50 via which the top part 22 rests upon the planar portion 19, corresponds, however, approximately to the length of the planar portion 19. The free end 50 extends beyond the planar portion 19 upon which it rests. The planar portion 19 can also be curved or bent in conformity with the side 47. Thus, between the planar portion 19 and that side 47 of the top part 22 that faces away from the side part 21, there is formed a distance 51 perpendicular to the longitudinal direction 9 of the chain. The side 47 is inclined relative to the longitudinal direction 9 of the chain, whereby the greatest distance 51 between the side 47 and the portion 19 of the depth limiter 18 is formed at that edge that faces the cutting tooth 15.

The planar portion 19 is formed on the cutter link 13 in the region of the front portion 28 of the main body 14. The angled-off portion 20 of the depth limiter 18 is formed on a connecting link 12 on the longitudinal side 45 of the saw chain 5. The longitudinal side 45 of the chain is disposed opposite the longitudinal side 44 of the chain on which the cutter link 13 is disposed. A marking 34, which indicates the condition of wear of the saw chain 5, is provided on the cutter link 13 in the region of the support surfaces 25, 26.

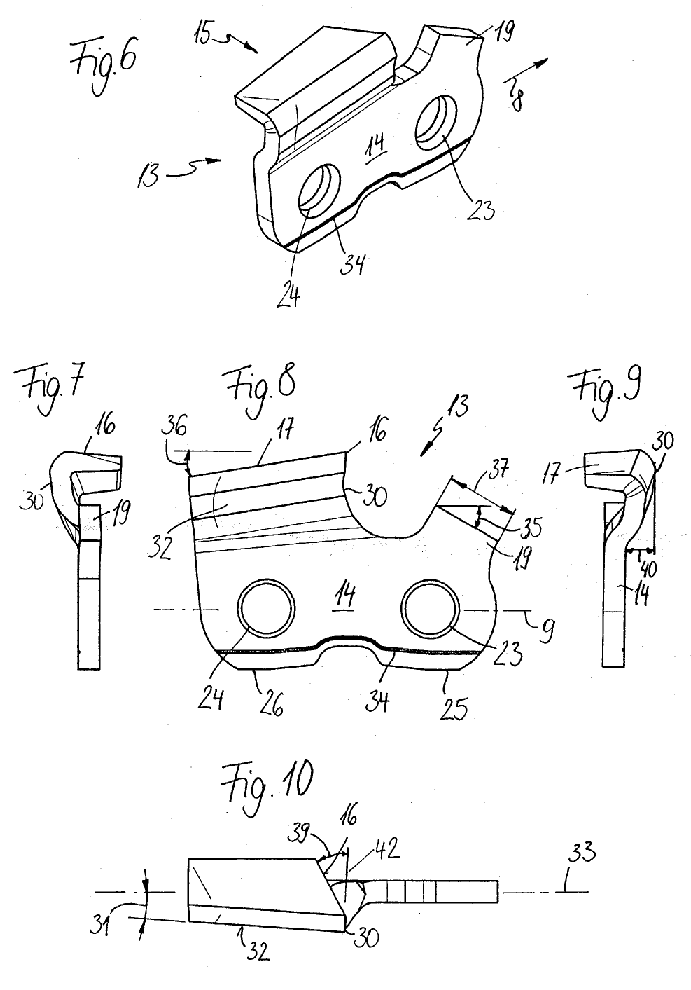

A cutter link 13 is illustrated in FIGS. 6 to 10. The tooth top 17 of the cutting tooth 15 is inclined relative to a line that is parallel to the longitudinal direction 9 of the chain by an angle of inclination 36, whereby the tooth top 17 slopes down counter to the direction of travel 8. The element 32 of the cutting tooth 15, which adjoins the tooth top 17, is inclined relative to the plane 33 of the main body 14 by an angle 31 (see FIG. 10), whereby the element 32 has the greatest distance from the plane 33 in the region of the side cutter 30. The angle 31 thus opens in the direction of travel. The top cutter 16 is inclined by an angle 39 relative to a line 42 that is perpendicular to the plane 33 of the main body 14, whereby the side cutter 30 is leading. The side cutter 30 has a distance 40 from the main body 14, whereby the distance 40 extends outwardly from the main body 14 relative to the saw chain 5. The planar portion 19 of the depth limiter 18 is inclined by an angle 35 relative to a line that is parallel to the longitudinal direction 9 of the chain, whereby the planar portion 19 slopes in the direction of travel 8.

Illustrated in FIGS. 11 to 15 is a connecting link 12 on which the angled-off portion 20 of the depth limiter 18 is formed. The side part 21 of the angled-off portion 20 is formed on the front portion 28 of the main body 14 of the connecting link 12, and forms a planar surface therewith. In this connection, the side part 21 extends approximately above the front rivet opening 23. The top part 22 is angled off approximately at right angles relative to the side part 21. The edge 41 of the top part 22 that is disposed counter to the direction of travel is inclined by an angle 43 relative to the line 42 that is perpendicular to the plane 33 of the main body 14. In this connection, the angle 43 corresponds to the angle of inclination 39 of the top cutter 16 of a following cutting tooth 15. The top part 22 is inclined relative to the longitudinal direction 9 of the chain by an angle 35 that corresponds to the angle of inclination 35 of the planar portion 19 of the depth limiter 18. That side 47 of the top part 22 that faces away from the side part 21 is inclined relative to the plane 33 of the main body 14 by an angle 52. The angle 52 opens counter to the direction of travel 8. The ratio of the angle 52 to the angle 35, about which the top part 22 is inclined in the plane 33 of the main body 14 relative to the longitudinal direction 9 of the chain, thereby corresponds approximately to the ratio of the angle 31, about which the cutting tooth 15 is inclined relative to the plane of the main body, to the angle 36, about which the cutting tooth is inclined in the plane of the main body relative to the longitudinal direction 9 of the chain. As a result, during re-grinding the distance 46 between the cutting tooth 15 and the depth limiter 18 perpendicular to the longitudinal direction 9 of the chain remains constant. The length 55 of the side part 21 in the region of the main body 14 is preferably approximately the same size, or greater than, the length 38 of the top part 22 on that side 56 that faces the side part 21. The depth limiter 18 is connected on its wide side.

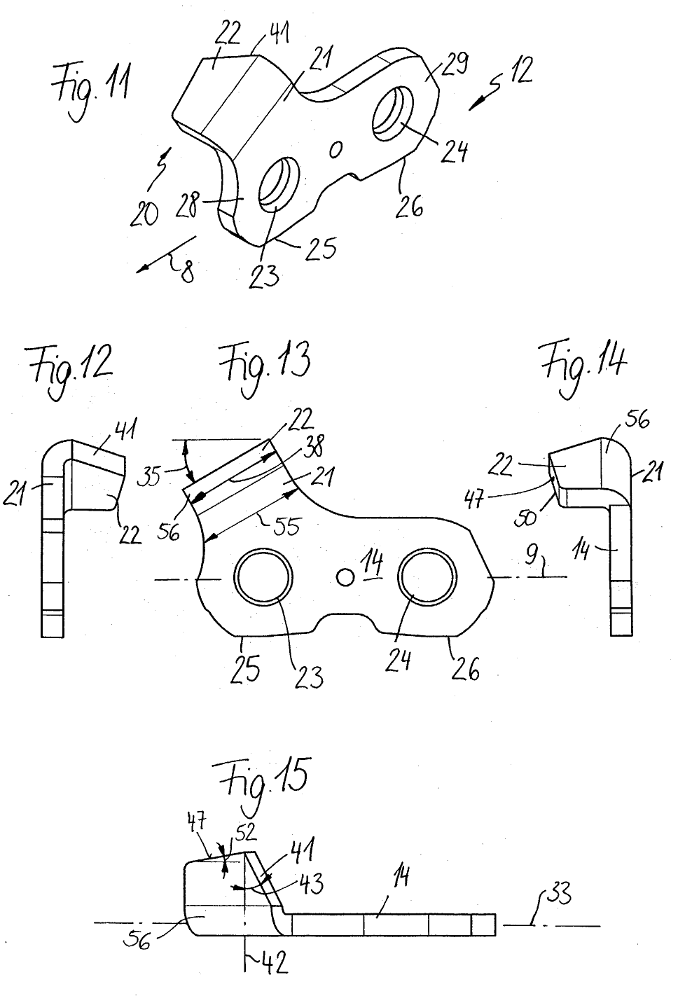

FIGS. 16 to 19 illustrate a portion of a saw chain 5 where the depth limiter 57, which leads the cutting tooth 15 of the cutter link 13, has a monolithic configuration. The depth limiter 57 has a planar part 21 and a top part 22. The planar part 21 adjoins the main body 14 of a connecting link 12 in a planar manner. The length 55 of the side part 21 in the region of the main body 14 is preferably the same size, or greater than, the length 38 of the top part 22 on that side 56 of the top part that faces the side part 21. The connecting link 12 on which the depth limiter 57 is formed is disposed across from the cutter link 13 on which the cutting tooth 15 is formed. The depth limiter 57 is thus fixed in position on a chain link that is disposed on an inner side 54 of the cutter link 13.

As illustrated in the plan view of FIG. 19, that side 41 of the depth limiter 57 that is disposed counter to the direction of travel 8 extends parallel to the top cutter 16, which is formed on that side of the cutting tooth 15 that is disposed in the direction of travel 8. In this connection, the edge 41 is inclined by an angle 43 relative to the line 42 that is perpendicular to the longitudinal direction 9 of the chain, and the top cutter 16 is inclined by an angle 39. The element 32 on which the side cutter 30 is formed is inclined relative to the longitudinal direction 9 of the chain by an angle 31 that opens counter to the direction of travel 8. That side 47 of the top part 22 that faces away from the side part 41 is inclined relative to the longitudinal direction 9 of the chain, by an angle 52 that opens in the direction of travel 8. In the plane 33 of the main body 14, the cutting tooth 15 is inclined relative to the longitudinal direction 9 of the chain by an angle 36, and the depth limiter 57 is inclined by an angle 35 relative thereto. The ratio of the angle 36 to the angle 31 on the cutting tooth 15 corresponds approximately to the ratio of the angle 35 to the angle 52 on the depth limiter 57. The side cutter 30 has a distance 46 relative to the side 47 of the top part 22 of the depth limiter 57 perpendicular to the longitudinal direction 9 of the chain.

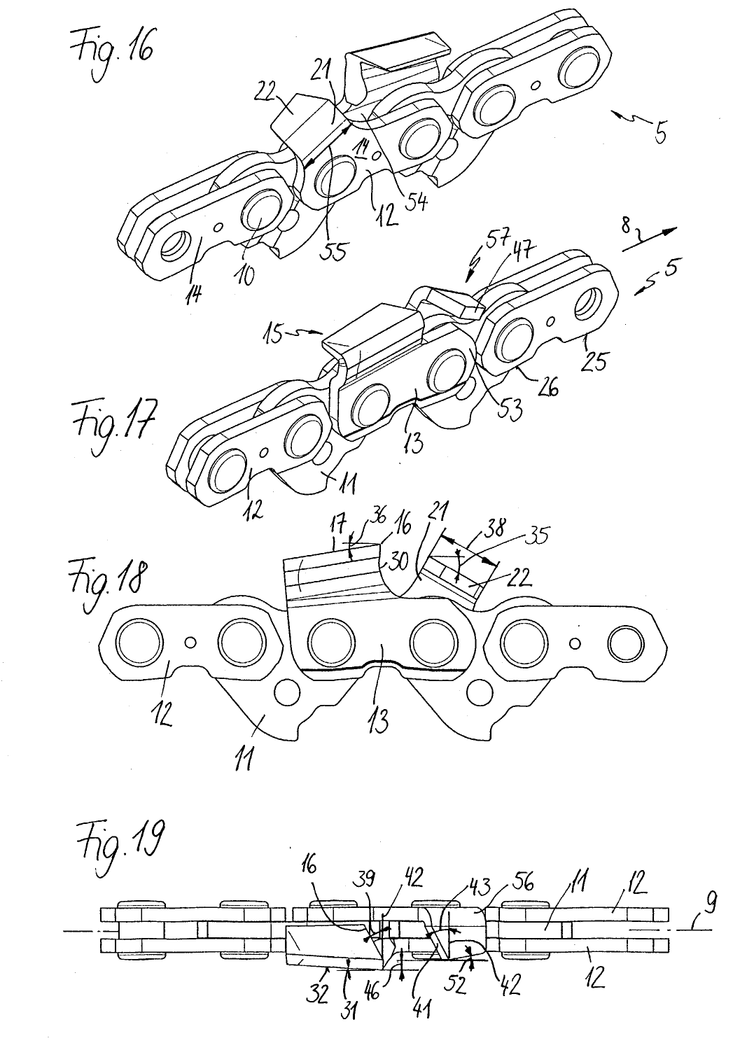

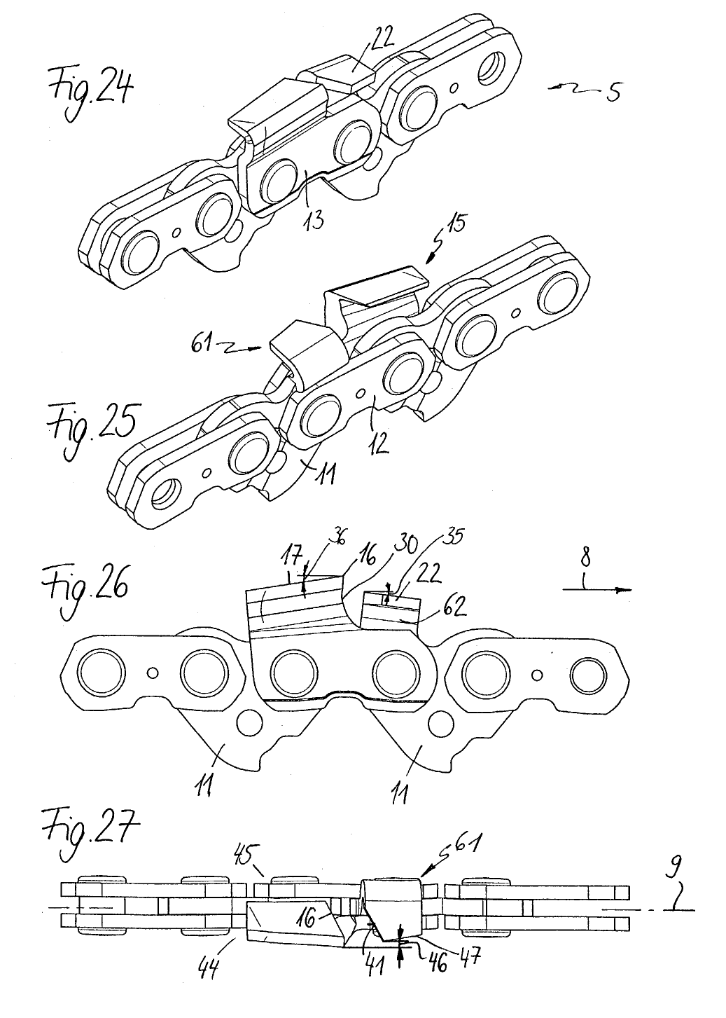

In FIGS. 20 to 23, a portion of a saw chain 5 is illustrated where a depth limiter 58 is fixed in position on a drive link 11 and leads a cutting tooth 15. The depth limiter 58 has a side part 59 that extends in an approximately planar manner relative to the main body 14 of the drive link 11 and has a top part 22 that is angled-off relative thereto. That side 47 of the top part 22 that faces away from the side part 59 is inclined by an angle 52 relative to the longitudinal direction 9 of the chain, and the element 32 of the cutting tooth 15 is inclined about the angle of inclination 31 relative to the longitudinal direction 9. In the plane 33 of the main body 14, the cutting tooth 15 is inclined by an angle 36 and the depth limiter 58 is inclined by an angle 35 relative to the longitudinal direction 9 of the chain. The ratio of the angle 36 to the angle 31 on the cutting tooth 15 corresponds approximately to the ratio of the angle 35 to the angle 52 on the depth limiter 58. The drive link 11 is formed on the inner side 51 of the cutter link 13, on which the cutting tooth 15 is formed. That edge 41 of the top part 22 that is disposed counter to the direction of travel extends approximately parallel to the top cutter 16 of the cutting tooth 15. The drive link 11 is shown in an enlarged view in FIGS. 28 to 31. That edge 41 of the top part 42 that is disposed to the rear in the direction of travel 8 forms an angle 43 with the line 42 that is perpendicular to the plane 33 of the main body 14. That side 47 that faces away from the side part 59 is inclined by an angle 52 relative to the plane 33 of the main body 14. In the region of the main body 14, the side part 59 has a length 60 that preferably corresponds at least to the length 38 of the top part 22 on that side 56 that faces the side part 59.

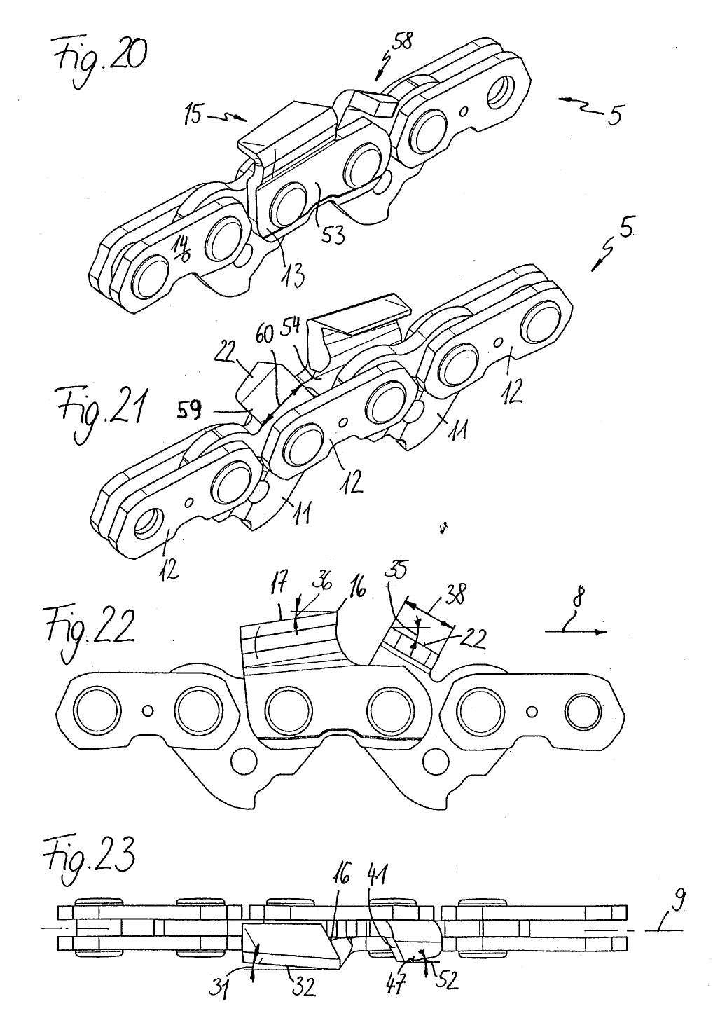

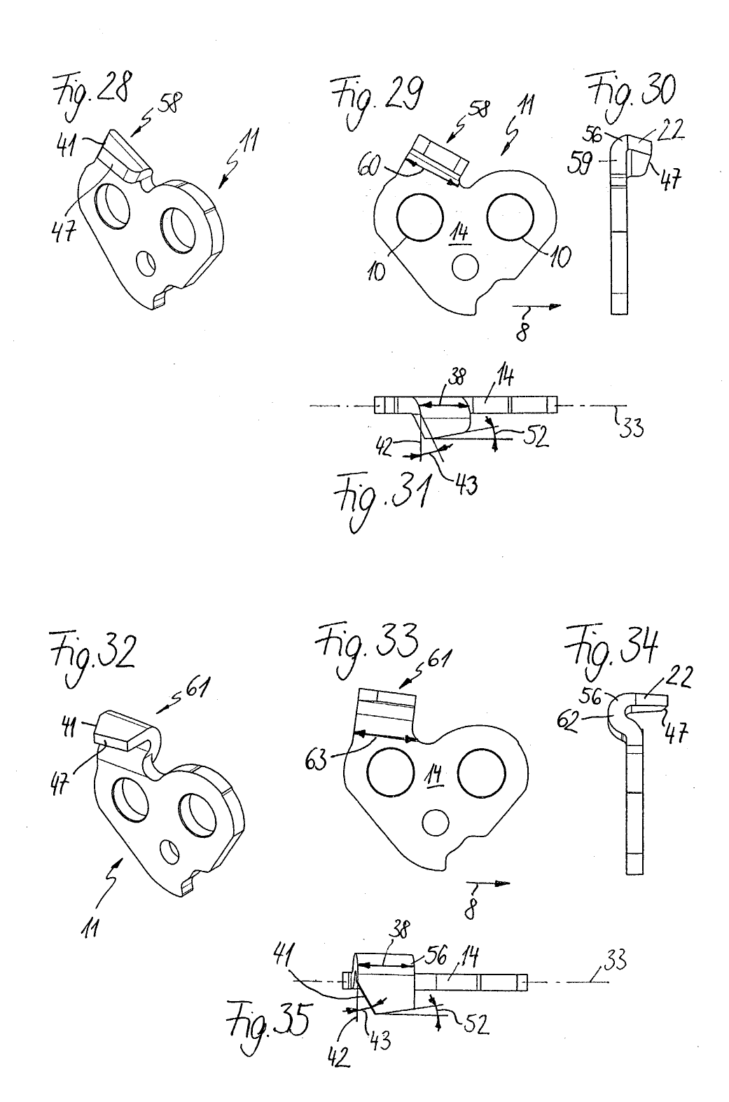

FIGS. 24 to 27 illustrate a portion of a saw chain 5 where a depth limiter 61 is formed on a drive link 11 and leads a cutting tooth 15. The cutter link 13 is disposed on the longitudinal side 44 of the chain. The depth limiter 61 has a side part 62 that projects from the drive link 11 to the opposite longitudinal side 45 of the chain. Adjoining the side part 62 is the top part 22, which projects over the entire width of the saw chain 5. That edge 41 of the depth limiter 61 that is disposed to the rear in the direction of travel 8 extends parallel to the top cutter 16 of the following cutting tooth 15. That side 47 of the top part 22 that faces away from the side part 62 has a distance 46 relative to the side cutter 30 of the cutting tooth 15 perpendicular to the longitudinal direction 9 of the chain. In FIGS. 32 to 35, an enlargement of the drive link 11 is illustrated. The side part 62 has a length 63 in the region of the main body 14. The length 63 preferably corresponds at least to the length 48 of the top part 22 on that side 46 that faces the side part 62. That edge 41 that is disposed to the rear in the direction of travel 8 is inclined by an angle 43 relative to a line 42 that is perpendicular to the plane 33 of the main body 14. That side 47 of the top part 22 that faces away from the side part 62 is inclined by an angle 52 relative to the longitudinal direction 9 of the chain, whereby the already described angle ratios preferably apply to the cutting tooth. The side part 62 has a curved configuration, approximately in the shape of a horizontal U.

It can be expedient that the depth limiter is inclined on both longitudinal sides 44,45 of the chain relative to the longitudinal direction 9 of the chain by an angle that opens counter to the direction of travel 8.

For the regrinding of a depth limiter, it is provided that the depth limiter, on that edge that is disposed to the rear in the direction of travel, be ground parallel to that edge of the cutting tooth that is disposed toward the front in the direction of travel. The regrinding can be effected via a grinding tool for the cutting tooth, for example via a grinding wheel or disk. Special depth limiter grinding wheels, and angular settings, are not required. Even with saw chains having only laterally offset depth limiters, it is possible via this grinding technique, and via appropriate selection of the angle ratios on the cutting tooth and the depth limiter, to keep the lateral distance relative to the depth limiter constant. The inventive method for the grinding can in particular also be utilized with other saw chains.

The specification incorporates by reference the disclosure of German priority document 102 21 944.3 filed May 17, 2002.

The present invention is, of course, in no way restricted to the specific disclosure of the specification and drawings, but also encompasses any modifications within the scope of the appended claims.

I claim:

1. A saw chain for a power chain saw, comprising:
centrally disposed drive links;
laterally disposed connecting links, wherein said drive links and said connecting links respectively have a flat main body, each of which has two rivet openings through which, transverse to a longitudinal direction of said chain, extend rivet pins for a pivotable connection of said links, wherein said connecting links have an outer side disposed on one longitudinal side of said chain, and an inner side disposed on an opposite side of said chain, wherein some of said connecting links are embodied as cutter links, wherein said cutter links have a cutting tooth formed on said main body; and
at least one depth limiter disposed in a manner so as to lead said cutting tooth in a direction of travel 8 of said chain, wherein said at least one depth limiter has at least one part that is fixed in position on one of said drive links and connecting links that is disposed on the inner side of said cutter link.

2. A saw chain according to claim 1, wherein an edge of said cutting tooth that is disposed toward the front as viewed in said direction of travel extends parallel to an edge of said leading depth limiter that is disposed toward the rear as viewed in said direction of travel.

3. A saw chain according to claim 1, wherein said at least one part of said depth limiter that is fixed in position on the inner side of said cutter link is provided with a side part and a top part that extends in a manner angled-off relative to said side part, and wherein said top part at least partially spans said saw chain.

4. A saw chain according to claim 3, wherein a length, of said side part in a region of said main body, corresponds at least to a length of said top part on a side thereof that faces said side part.

5. A saw chain according to claim 1, wherein said cutting tooth, on said one longitudinal side of said chain on which a pertaining cutter link is disposed, is inclined relative to a plane of said main body by a first angle that opens in said direction of travel, wherein an upper, outer edge of said leading depth limiter on said one longitudinal side of said chain, is inclined relative to said plane of said main body by a second angle that opens counter to said direction of travel, wherein a ratio of said first angle of inclination of said cutting tooth to a third angle of inclination of said cutting tooth relative to said longitudinal direction of said chain in said plane of said main body corresponds approximately to a ratio of said second angle of inclination of said depth limiter to a fourth angle of inclination of said depth limiter relative to said longitudinal direction of said chain in said plane of said main body.

6. A saw chain according to claim 1, wherein said depth limiter is spaced, in a direction perpendicular to said longitudinal direction of said chain, by a distance relative to a following cutting tooth on said one longitudinal side of said chain on which said cutter link is disposed.

7. A saw chain according to claim 1, wherein said depth limiter has a free end, and wherein said depth limiter is supported relative to said saw chain in the region of said free end.

8. A saw chain according to claim 1, wherein said depth limiter has an approximately U-shaped configuration.

9. A saw chain according to claim 1, wherein said depth limiter is formed of at least two portions.

10. A saw chain according to claim 9, wherein one of said sections of said depth limiter adjoins the main body of a connecting link in a planar manner.

11. A saw chain according to claim 10, wherein said planar portion of said depth limiter, in a manner such that it leads a cutter link, is disposed on said outer side of said cutter link on said one longitudinal side of said chain.

12. A saw chain according to claim 11, wherein said planar portion of said depth limiter is monolithically formed with a cutter link.

13. A saw chain according to claim 1, wherein a portion of said depth limiter is monolithically formed with a connecting link that is disposed opposite a cutter link.

14. A saw chain according to claim 1, wherein a portion of a depth limiter is monolithically formed with a drive link.

15. A saw chain according to claim 1, wherein said depth limiter, not only on said one longitudinal side of said chain upon which a pertaining cutter link is disposed, but also upon the oppositely disposed longitudinal side of said chain, is inclined relative to said longitudinal direction of said chain by an angle that opens counter to said direction of travel.

16. A method of sharpening or grinding a saw chain for a power chain saw formed of centrally disposed drive links and laterally disposed connecting links, wherein some of said connecting links are embodied as cutter links that have a cutting tooth, and wherein a depth limiter is provided for each cutting tooth and leads said cutting tooth, said method including the step of:
grinding an edge of said depth limiter that is disposed toward the rear as viewed in a direction of travel of the chain, wherein said grinding is effected parallel an edge of said cutting tooth that is disposed toward the front as viewed in said direction of travel.

17. A method according to claim 16, wherein said depth limiter, not only on a longitudinal side of said chain upon which a pertaining cutter link is disposed, but also upon an oppositely disposed longitudinal side of said chain, is inclined relative to a longitudinal direction of said chain by an angle that opens counter to said direction of travel, and wherein during sharpening or grinding, both sides are shortened such that a distance of said depth limiter to said cutting tooth, perpendicular to said longitudinal direction of said chain, remains constant on both longitudinal sides of said chain.
